(19) United States
(12) Patent Application Publication
(10) Pub. No.: US 2010/0323577 A1
(43) Pub. Date: Dec. 23, 2010

(54) METHOD FOR PRODUCING PLASMA DISPLAY PANEL

(75) Inventors: Kenji SATO, Osaka (JP); Syouzou NINOMIYA, Osaka (JP); Shougo NASU, Hyogo (JP); Hisayo OOHATA, Osaka (JP); Kenji HASEGAWA, Osaka (JP)

Correspondence Address: HAMRE, SCHUMANN, MUELLER & LARSON P.C., P.O. BOX 2902, MINNEAPOLIS, MN, 55402-0902, US

(73) Assignee: PANASONIC CORPORATION, Osaka (JP)

(21) Appl. No.: 12/817,843

(22) Filed: Jun. 17, 2010

(30) Foreign Application Priority Data
Jun. 22, 2009 (JP) 2009-147411
Jun. 25, 2009 (JP) 2009-150624

(51) Int. Cl. H01J 9/00

(52) U.S. Cl. 445/24

(57) ABSTRACT

The present invention provides a method for producing a plasma display panel, including a step of providing a back substrate with a barrier rib to form a plurality of recesses separated each other by the barrier rib, and a step of applying a phosphor ink to the recesses using an inkjet device, wherein the phosphor ink contains a phosphor having a median particle diameter of not less than 1.0 μm, and a solvent, and an initial speed of the phosphor ink ejected from a nozzle hole of the inkjet device is not less than 4 m/s and not more than 10 m/s.

### BACKGROUND OF THE INVENTION

1. Field of the Invention

The present invention relates to a method for producing a plasma display panel that is used for image display, particularly to a method for producing the plasma display panel using an inkjet device.

2. Description of Related Art

In recent years, a plasma display panel (hereinafter, abbreviated as PDP) has attracted attention as a color display device that can achieve a large but thin screen with a light weight.

In the PDP, image display is performed by making use of light emission from phosphor layers. For forming a phosphor layer in the production of a PDP, inkjet techniques have been proposed (e.g., see JP-A-2004-63246). Specifically, JP-A-2004-63246 discloses a method wherein an ink in which a phosphor having an average particle diameter of not less than 0.001 μm and less than 1.0 μm is dispersed in an organic solvent is prepared and then ejected from an end of an inkjet head. When discharge cells are arranged more finely for higher definition along with higher pixel counts for a plasma display panel, it becomes difficult to apply a phosphor ink to each discharge cell. However, according to a method for applying a phosphor ink using an inkjet device, application of a phosphor ink to each discharge cell with high definition is easy.

However, in order to use the above phosphor having an average particle diameter of not less than 0.001 μm and less than 1.0 μm, it is required to crush a phosphor into a smaller size or classify a phosphor powder by sieving. When the phosphor is crushed, it is considered that the luminance may be degraded and thus the emission properties of a PDP can be insufficient. On the other hand, when a phosphor having an average particle diameter of less than 1.0 μm is obtained by sieving, the yield is low. Furthermore, a phosphor having a small particle size agglomerates easily, and this causes a problem in that the dispersion of the phosphor into an ink is difficult.

### SUMMARY OF THE INVENTION

In contrast, it is considered to use a phosphor having a median particle diameter of not less than 1.0 μm. The inventors of the present invention have studied this and have found that when phosphor particles having a median particle diameter of not less than 1.0 μm, such as phosphor particles shown in FIG. 6, are used in the inkjet technique, it is very difficult to allow the phosphor particles in the phosphor ink to move (flow) in an inkjet head so as to follow the movement (flow) of the phosphor ink. Furthermore, phosphor particles having a large particle diameter precipitate easily in the phosphor ink, and thus, only phosphor particles having a small particle diameter are ejected from a nozzle hole. This causes a problem in that the concentration (content) of the phosphor particles in the ejected phosphor ink varies and is not kept constant. In this case, the thicknesses of the phosphor layers become uneven, resulting in poor quality of an image of a PDP.

In view of the foregoing, it is an object of the present invention to provide a method for producing a plasma display panel in which an ink containing phosphor particles having a median particle diameter of not less than 1.0 μm can be ejected stably using an inkjet device.

The above object can be attained by the following production method. It is a method for producing a PDP, including a step of providing a back substrate with a barrier rib to form a plurality of recesses separated each other by the barrier rib, and a step of applying a phosphor ink to the recesses using an inkjet device,

wherein the phosphor ink contains a phosphor having a median particle diameter of not less than 1.0 μm, and a solvent, and

an initial speed of the phosphor ink ejected from a nozzle hole of the inkjet device is not less than 4 m/s and not more than 10 m/s.

According to the present invention, a method for producing a plasma display panel can be provided in which an ink containing phosphor particles having a median particle diameter of not less than 1.0 μm can be ejected stably using an inkjet device.

### BRIEF DESCRIPTION OF THE DRAWINGS

FIG. 1 is an exploded perspective view showing the structure of the PDP in the first embodiment of the present invention.

FIG. 2 is a sectional view of the discharge cell portion of the PDP in the first embodiment of the present invention.

FIG. 3 shows the electrode arrangement of the PDP in the first embodiment of the present invention.

FIG. 4 is a sectional view of the main portion showing one example of the ejection of the ink droplet in the first embodiment of the present invention.

FIG. 5 shows the cross-sectional shape of the discharge cell after applying the phosphor ink in the first embodiment of the present invention.

FIG. 6 shows the particle size distributions of the each phosphor.

FIG. 7 shows the relationship between the initial speed and the 90th percentile D₉₀ of the particle size distribution in the case of the Stokes number S of 0.1

FIG. 8 is a schematic view of one example of the structure of the PDP device using the PDP produced by the present invention.

### DETAILED DESCRIPTION OF THE INVENTION

### First Embodiment

### Structure of PDP

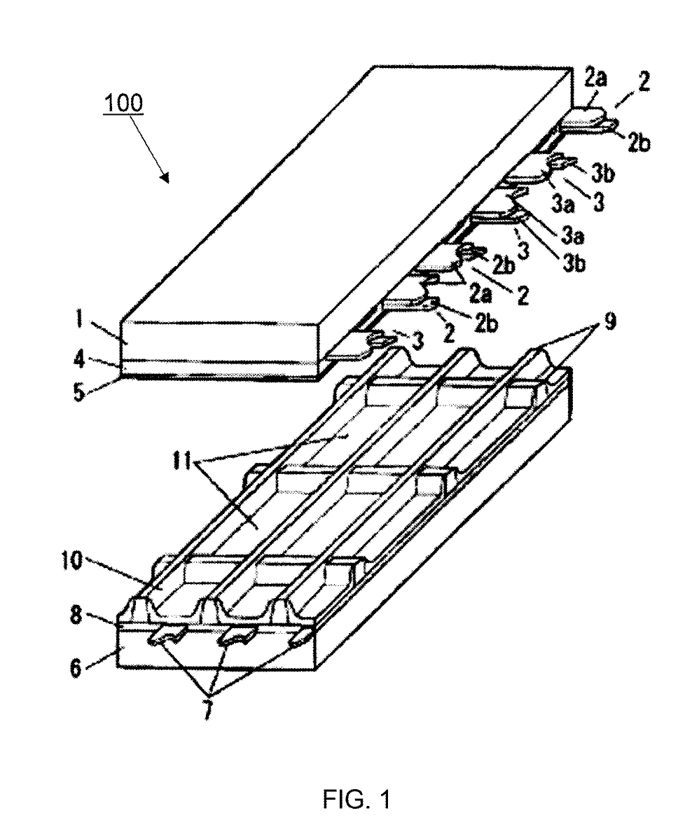

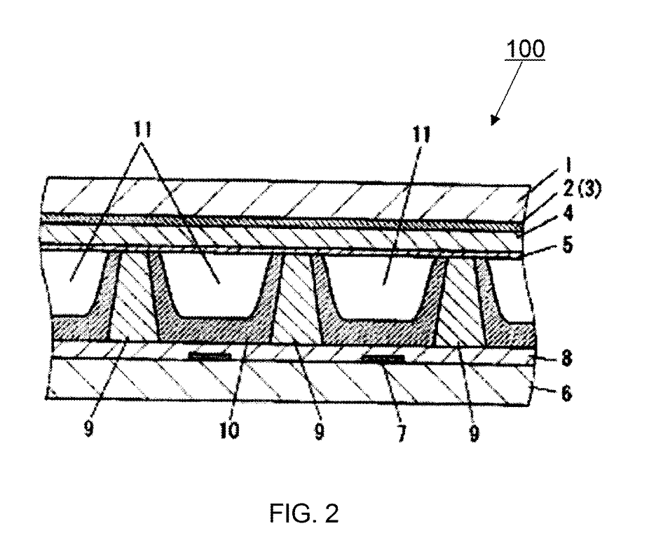

First, a general structure of a PDP to be produced is described. FIG. 1 is an exploded perspective view showing a structure of a PDP 100 in the first embodiment of the present invention, and FIG. 2 is a sectional view of a main portion of a discharge cell.

As shown in FIG. 1, the PDP 100 includes a front panel and a back panel with these panels being arranged facing each other. A large number of discharge cells 11 are formed between the front panel and the back panel.

The front panel includes a front substrate 1, scan electrodes 2, sustain electrodes 3, a dielectric layer 4, and a protective layer 5. The front substrate 1 is made of glass. A display electrode is composed of a pair of the scan electrode 2 and the sustain electrode 3, and a plurality of the display electrodes are formed parallel on the front substrate 1. The scan electrodes 2 and the sustain electrodes 3 are formed in a pattern in which an arrangement of a scan electrode 2-a sustain electrode 3-a sustain electrode 3-a scan electrode 2 is repeated. A dielectric layer 4 is formed so as to cover the display electrodes. Further, a protective layer 5 made of MgO is formed so as to cover the dielectric layer 4. Each of the scan electrodes 2 and the sustain electrodes 3 is made of conductive metal oxide such as ITO, SnO₂, or ZnO. Bus electrodes 2b, 3b that are made of metal such as Ag are formed on transparent electrodes 2a, 3a that have optical transparency.

The back panel includes a back substrate 6, data electrodes 7, a dielectric layer 8, and a barrier rib 9. The back substrate 6 is made of glass. A plurality of the data electrodes 7 made of a conductive material mainly containing Ag are formed parallel on the back substrate 6. The dielectric layer 8 is formed so as to cover the data electrodes 7. Further, the barrier rib 9 shaped as a grid is formed on the dielectric layer 8. The barrier rib 9 separates adjacent discharge spaces. Phosphor layers 10 having any one color of red, green and blue are formed on the surface of the dielectric layer 8 and the side of the barrier rib 9.

The front panel and the back panel are arranged facing each other so that the data electrodes 7 intersect with the scan electrodes 2 and the sustain electrodes 3. The periphery of bonding surfaces of the front panel and the back panel is sealed. The discharge spaces are formed between the front panel and the back panel. In the discharge spaces, a discharge gas is enclosed.

Here, as shown in FIG. 2, in the discharge spaces between the front panel and the back panel, discharge cells 11 surrounded by the barrier rib 9 are formed. The discharge cell 11 is formed between the data electrode 7, and the scan electrode 2 and sustain electrode 3.

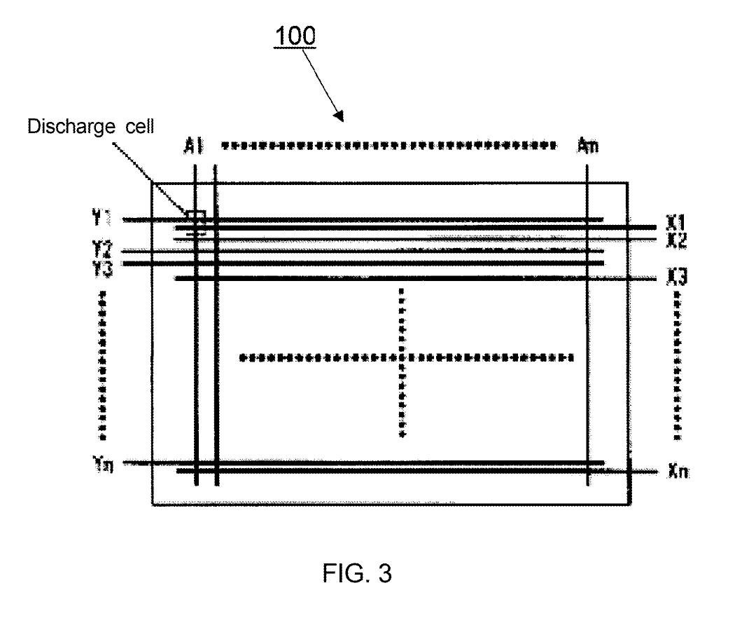

FIG. 3 shows an arrangement of the electrodes of the PDP 100 in the embodiment. N long scan electrodes Y1, Y2, Y3 . . . Yn (2 in FIG. 1) and n long sustain electrodes X1, X2, X3 . . . Xn (3 in FIG. 1) are arranged in a row direction, and m long data electrodes A1 . . . Am (7 in FIG. 1) are arranged in a column direction. A discharge cell is formed in the area where the data electrode A1 intersects with a pair of the scan electrode Y1 and the sustain electrode X1. M×n discharge cells are formed in the discharge spaces. Each of the electrodes is connected to connection terminals provided in a peripheral edge located outside of an image display area of a front panel and a back panel.

### (Production Method)

Hereinafter, a method for producing the PDP 100 according to the embodiment will be described.

The method for producing the PDP 100 typically can include a step of forming a front panel, a step of forming a back panel, a step of sealing the front panel and the back panel peripherally to form a discharge space, and a step of sealing a discharge gas into the discharge space after exhausting atmospheric air out of the discharge space. The step of forming a back panel includes a step of providing a back substrate with a barrier rib to form a plurality of recesses separated each other by the barrier rib, and a step of applying a phosphor ink to the recesses using an inkjet device. Since conventional steps of a method for producing a PDP can be applied to the steps other than the step of applying a phosphor ink, explanations of those steps are omitted.

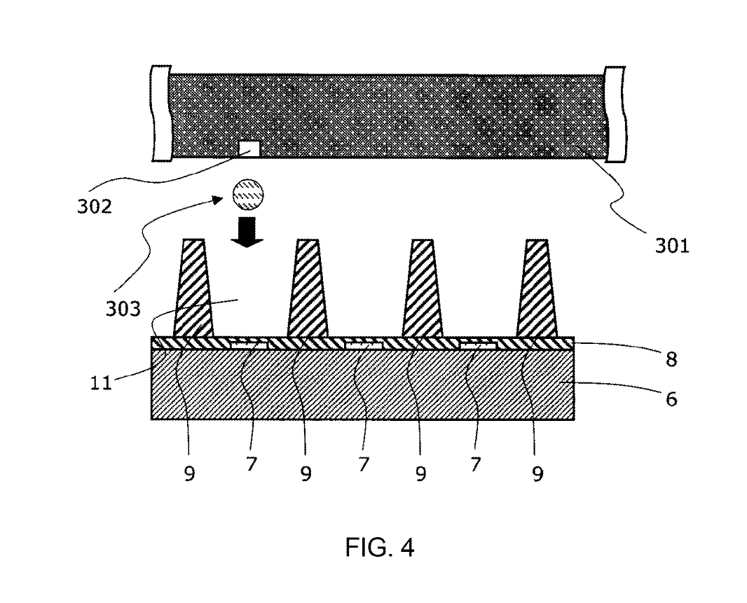

The step of applying a phosphor ink will be described in detail. FIG. 4 is a sectional view of the main portion showing one example of the ejection of the ink droplet in the embodiment. For applying a phosphor ink, an inkjet device is used. Specifically, for example, a phosphor ink containing a phosphor is prepared. An inkjet head 301 is allowed to move across the back panel to scan. From a nozzle hole 302 provided with the inkjet head 301, the phosphor ink (droplet 303) ejected in one ejection is dropped into a discharge cell 11.

The initial speed of the phosphor ink ejected in one ejection from the nozzle hole 302 of the inkjet device is not less than 4 m/s and not more than 10 m/s. In this case, the phosphor ink containing the phosphor having a median particle diameter of not less than 1.0 μm can be ejected stably using an inkjet device. The diameter of the nozzle hole 302 is preferably not more than 30 μm, since the initial speed of the phosphor ink (droplet 303) ejected from the nozzle hole can be adjusted easily to be not less than 4 m/s and not more than 10 m/s.

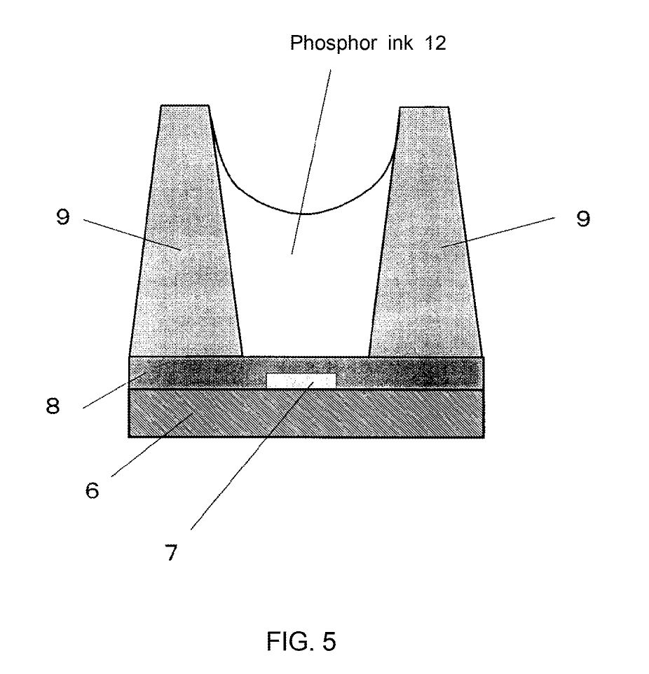

The volume of the droplet 303 (the amount of the ink) to be dropped is adjusted considering the wettability of the phosphor ink relative to the material of the back substrate 6 and the like. The volume of the droplet 303 is preferably less than 1/100 of the internal volume of the discharge cell 11. In this case, the phosphor ink can be ejected more accurately into the intended discharge cell 11, and therefore, the high yield can be achieved. FIG. 5 shows the cross-sectional shape of the discharge cell 11 after applying the phosphor ink 12 to the barrier rib 9. It is preferable that the phosphor ink be filled to 30% or more of the internal volume of the recess. In this case, a phosphor layer having a sufficient thickness with little degradation of luminance can be formed.

As a material of a blue phosphor, for example, BaMgAl₁₂O₁₇:Eu³⁺, BaMgAl₁₀O₁₇:Eu²⁺, BaMgAl₁₄O₂₃:Eu²⁺, Y₂SiO₅:Ce, (Ca, Sr, Ba)₁₉(PO₄)₆C₁₂:Eu²⁺, and (Zn, Cd)S:Ag may be used.

As a material of a green phosphor, for example, BaAl₁₂O₁₉:Mn, Zn₂SiO₄:Mn, and YB0₃:Tb may be used.

As a material of a red phosphor, for example, YBO₃:Eu³⁺, (YₓGd₁₋ₓ)BO₃:Eu³⁺ (0≦X≦1), and Y(P, V)O₄:Eu³⁺ may be used. As a matter of course, materials of a blue phosphor, a green phosphor and a red phosphor are not limited thereto.

In the embodiment, the median particle diameter of the phosphor of each color is not less than 1.0 μm. The phosphor having a median particle diameter of not less than 1.0 μm has high luminance. The median particle diameter is preferably not less than 1.5 μm. In this regard, the maximum diameter of the phosphor has to be smaller than the diameter of the nozzle hole of the inkjet device, and is preferably 60% or less of the diameter of the nozzle hole. With consideration given to a diameter of a nozzle hole of an inkjet device commonly used, the median particle diameter of the phosphor is preferably not more than 10 μm, more preferably not more than 7 μm, and further preferably not more than 5 μm, from the viewpoint of preventing nozzle clogging. It should be noted that the median particle diameter here means a medium value (median) of a particle size distribution of phosphor particles contained in a phosphor ink. The medium value can be determined statistically from the particle size distribution of a phosphor that is measured, for example, by a laser diffraction and scattering method on a sample taken from a stirred phosphor ink.

A blue phosphor ink contains a blue phosphor. A green phosphor ink contains a green phosphor. A red phosphor ink contains red phosphor. In each phosphor ink, the phosphor particles are dispersed in a solvent such as butyl carbitol acetate and terpineol, in which a binder such as ethyl cellulose is dissolved. A dispersant is added to the each phosphor ink. The amount of the dispersant to be added is, for example, 0.5 to 2 wt % with respect to the weight of the phosphor. As the dispersant, for example, acrylic copolymers, alkyl ammonium salts, siloxanes, and the like may be used.

The viscosity of each phosphor ink at 25° C. is preferably not less than 10 mPa·s and not more than 50 mPa·s. Such a low viscosity can be achieved by using a phosphor having the median particle diameter of not less than 1.0 μm. The viscosity can be adjusted to not less than 10 mPa·s and not more than 50 mPa·s by adjusting the molecular weight and content of the binder such as ethyl cellulose. When the viscosity of the each phosphor ink is less than 10 mPa·s, the phosphor particles settle rapidly, and then precipitate and agglomerate in the inkjet device. Consequently, the concentration (content) of the phosphor particles in the ink droplet ejected from the nozzle hole of the inkjet head may vary and may not be kept constant. As a result, the phosphor layer 10 may not be formed on the side of the barrier rib so as to have a uniform thickness. On the other hand, when the viscosity is more than 50 mPa·s, ejection of the ink from the nozzle hole of the inkjet head may become difficult.

The amount of the phosphor ink to be applied to one discharge cell is determined in advance, and therefore, the maximum thickness of the phosphor layer to be formed in one cycle including application, drying, and firing of the phosphor ink is determined by the amount of the phosphor ink and the content of the phosphor in the phosphor ink. In order to form a phosphor layer having a predetermined thickness after drying and firing, the cycle including application and drying of the phosphor ink has to be preformed several times. However, the more times the cycle is repeated, the lower the productivity becomes. In light of this, the content of the each phosphor in the each phosphor ink is preferably not less than 30 wt % and not more than 70 wt %. Such a high content of the phosphor can be achieved by using a phosphor having a median particle diameter of not less than 1.0 μm. When the content of the phosphor ink falls in the above range, a phosphor layer having a desired thickness can be formed with a smaller number of cycles that include application and drying of the phosphor ink. For example, the phosphor layer having a predetermined thickness can be formed by performing one cycle. When the content of the phosphor in the phosphor ink is less than 30 wt %, the content of the phosphor in the phosphor ink to be applied in one cycle is small. Therefore, in order to feed the phosphor ink at a sufficient amount for the internal volume of the barrier rib, larger number of the cycles of application and drying has to be performed, and this may result in low productivity. On the other hand, when the content of the phosphor in the phosphor ink exceeds 70 wt %, the fluidity of the ink decreases since the content of the solvent is small. Hence, the ejection of the ink may become difficult. It should be noted that the phosphor ink may be ejected from the inkjet head several times in one application of the phosphor ink.

The specific gravity of the phosphor ink is preferably not less than 1.1 g/cm³. In this case, the thickness of the phosphor ink that can be applied in one scan is large, and therefore, it is possible to apply the phosphor ink to have a predetermined thickness in, for example, one scan. On the other hand, the specific gravity of the phosphor ink is preferably not more than 1.6 g/cm³.

As an example of the embodiment, an ink containing 50 wt % of a phosphor having a median particle diameter of 2 μm and a dispersant whose content was 0.5 wt % with respect to the weight of the phosphor was used for the each phosphor ink. As a solvent of the each phosphor ink, butyl carbitol acetate and terpineol were used. Further, a binder such as ethyl cellulose was added thereto. The viscosity of the each phosphor ink was measured at 25° C. and found to be 20 mPa·s.

After each of the blue phosphor ink, green phosphor ink and red phosphor ink was dropped to each discharge cell 11, a drying step is performed in which each phosphor ink is heated at the temperature of, for example, 80° C. or more to dry the phosphor inks. In this case, the heating should be carried out at the temperature at which the ink component such as a dispersant does not decompose. Here, the heating temperature is determined depending heavily on the kind of the solvent used for each phosphor ink, atmosphere, an exhaust speed, and the like.

Next, a firing step in which the each phosphor ink is heated at 100° C. or more is performed. After the firing step, the back panel of the PDP is completed. The dispersed dispersant component can be decomposed sufficiently by performing the firing step, and the influence of the dispersant on the properties (e.g., emission luminance) of the PDP can be reduced. The heating temperature in the firing step is determined depending heavily on the kind of the solvent used for the each phosphor ink, atmosphere, an exhaust speed, decomposition temperatures of additives and a dispersant and the like. The firing step may be performed at the temperature at which residual components of the additives, the dispersant and the like can be decomposed to the extent where the residual components do not influence the properties of the PDP.

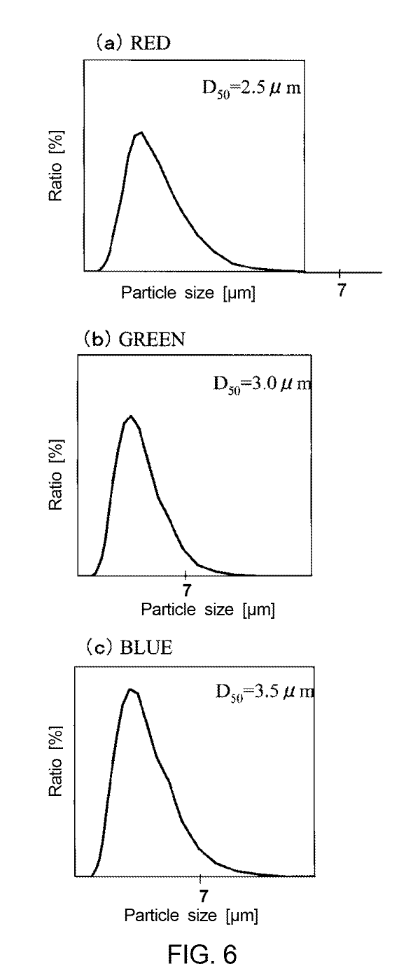

Hereinafter, studies that were made for ejecting an ink containing phosphor particles having a median particle diameter of not less than 1.0 μm stably using an inkjet device will be described. FIG. 6 shows particle size distributions of each phosphor used in the following studies. As a red phosphor, a phosphor having a median particle diameter (D₅₀) of 2.5 μm was used. As a green phosphor, a phosphor having a median particle diameter (D₅₀) of 3.0 μm was used. As a blue phosphor, a phosphor having a median particle diameter (D₅₀) of 3.5 μm was used. The green phosphor and the blue phosphor contained particles having a particle diameter of 7 μm or more.

### (Investigation of Ejection Speed of Droplet 303)

The result that an initial speed of a phosphor ink to be ejected in one ejection from a nozzle hole 302 of an inkjet device should be not less than 4m/s and not more than 10 m/s has been found by the following experiment.

An inkjet device can not be used for a production of a PDP as long as the inkjet device ejects a droplet 303 stably while the ejection of the droplet 303 is repeated continuously. There, the result of the experiment to investigate the relationship between the ejection stability and the initial speed of droplet 303 when the phosphor ink containing phosphor particles was ejected from the inkjet device is shown in Table 1.

TABLE 1

| Experiment | Stability |
|---|---|
| Droplet speed [m/s] < 4 [m/s] | Unstable |
| 4 [m/s] ≦ Droplet speed [m/s] ≦ 10 [m/s] | Stable |
| 10 [m/s] < Droplet speed [m/s] | Unstable |

In the experiment, a phosphor ink containing a green phosphor having the particle size distribution shown in FIG. 6(b) was used as a sample. The phosphor ink contained 20 wt % or more of the green phosphor and a dispersant whose content was 0.5 wt % or more with respect to the weight of the phosphor. The solvent of the phosphor ink contained butyl carbitol acetate as a main component, and ethyl cellulose was added to the phosphor ink as a binder. The viscosity of the phosphor ink was measured at 25° C. and found to be 7 mPa·s or more.

Ejection under each condition was carried out continuously for 1 hour. In each condition, the ejection force of the inkjet head 301 was changed increasingly. During the ejection, whether the droplets 303 were ejected stably or unstably was observed using a camera. In Table 1, the results were shown as unstable for the case where separation of the dropped was occurred, the ink was not ejected, and the ink was ejected unstably. For the ejection, the nozzle hole 302 of the inkjet head 301 with the diameter of 20 μm was employed.

In the experiment, the ejection force of the inkjet head 301 was increased gradually. Until the initial speed of the droplet 303 reached 4 m/s, the phosphor ink was not ejected from the nozzle hole 302 (non-ejected state), or the phosphor ink was not stably ejected continuously even though the phosphor ink was ejected (unstable state).

When the initial speed of the droplet 303 was not less than 4 m/s and not more than 10 m/s, the phosphor ink was ejected stably. Specifically, under the condition in which the initial speed of the droplet 303 was 4 m/s, 6 m/s, 8 m/s, and 10 m/s, ejection stably was carried out continuously for 1 hour.

When the initial speed of the droplet 303 was more than 10 m/s, the phosphor ink was ejected occasionally with the phosphor ink being sprayed (separation state) during the continuous ejection for 1 hour. Specifically, under the condition in which the initial speed of the droplet 303 was 11 m/s, the separation state was observed during the continuous ejection for 1 hour. Furthermore, printing failure in which the phosphor ink dropped not into the predetermined discharge cell but into the adjacent discharge cell occurred.

### (Investigation of Viscosity of Phosphor Ink)

In production of a PDP, the quality of an image of a PDP deteriorates if a phosphor ink is not ejected with the concentration of the phosphor ink kept constant. Accordingly, the results of the experiment on the concentration of the ejected ink using the phosphor ink (I) and phosphor ink (II) containing the red phosphor and blue phosphor, respectively, having the different particle size distribution shown in FIG. 6 were shown in Table 2. In the experiment, the initial speed of the each phosphor ink to be ejected was set to 6 m/s. The ink viscosity was about 7 mPa·s. The median particle diameters of the phosphors contained in both of the phosphor ink (I) and the phosphor ink (II) used in the experiment were 1.0 μm or more. The specific gravity of each phosphor ink was 1.1 g/cm³. The diameter of the nozzle hole 302 of the inkjet head 301 used in the experiment was 20 μm.

TABLE 2

| | Concentration of ink ejected from inkjet nozzle hole |
|---|---|
| | Concentration of supplied ink [%] |
| Phosphor ink (I) | 100% |
| Phosphor ink (II) | 62% |

As the result, with respect to the phosphor ink (I), the ratio of the concentration of the phosphor ink ejected from the nozzle hole 302 relative to the concentration of the supplied phosphor ink was 100%. That is to say, the concentration of the supplied phosphor ink was the same as the concentration of the phosphor ink ejected from the nozzle hole. However, with respect to the phosphor ink (II), the ratio of the concentration of the ejected phosphor ink relative to the concentration of the supplied phosphor ink was about 62%. That is to say, the concentration of the ejected phosphor ink was smaller than that of the supplied phosphor ink.

Therefore, a simulation was carried out in order to confirm the relationship between the particle diameter and the ejection concentration. The mathematical formula (I) is a formula for calculating the Stokes number S in the case where a phosphor ink is ejected using an inkjet device. Here, ρ denotes a specific gravity (kg/m³) of the phosphor ink, D₉₀ denotes the 90th percentile (m) of the particle size distribution of the phosphor in the phosphor ink, u denotes the initial speed (m/s) of the phosphor ink when ejected, μ denotes the viscosity (Pa·s) of the phosphor ink, and L denotes the diameter (m) of the nozzle hole 302. In the formula, a particle diameter, characteristic dimension, and velocity in a general formula of the Stokes number are substituted for the 90th percentile of the particle size distribution of the phosphor in the phosphor ink, the diameter of the nozzle hole 302, and the initial speed of the phosphor ink when ejected, respectively. This is a new attempt by the inventors.

$$S = \frac{ρ {D}_{90}^{2} u}{18 μ L} \qquad ( 1 )$$

The 90th percentile D₉₀ of the particle size distribution of the red phosphor in the phosphor ink (I) was about 3 μm. The 90th percentile D₉₀ of the particle size distribution of the blue phosphor in the phosphor ink (II) was about 8 μm. Consequently, the Stokes number S of the phosphor ink (I) was 0.02, and the Stokes number S of the phosphor ink (II) was 0.17. Therefore, it is found that with respect to the phosphor ink having the Stokes number S that is much smaller than 1, specifically, 0.1 or less, the change in the concentration is small before and after the ejection from the nozzle hole 302 of the inkjet head 301.

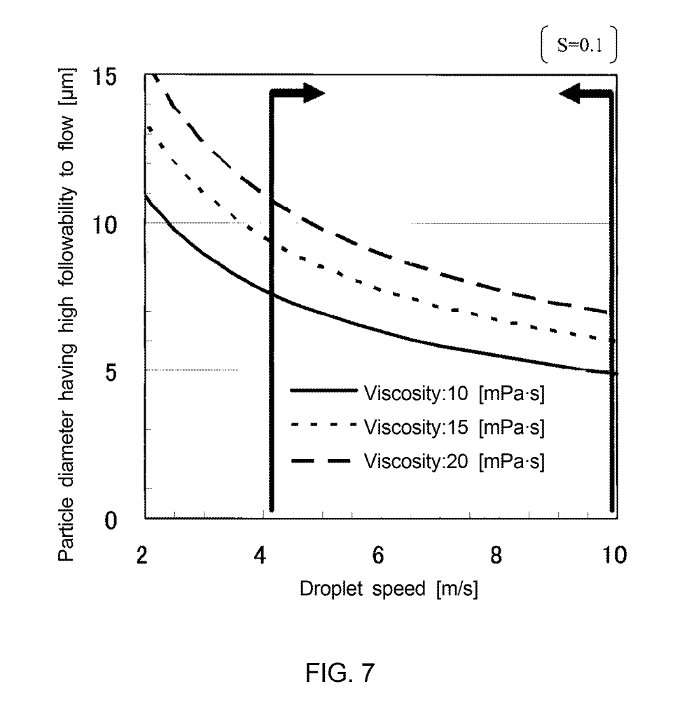

Based on the above-mentioned results of the experiments and the simulation, a further simulation was carried out for ejecting a phosphor ink at a stable concentration. The results are shown in FIG. 7. FIG. 7 shows the results of the simulation of the relationship between the initial speed and the 90th percentile D₉₀ of the particle size distribution in the case of the Stokes number S of 0.1. In other words, FIG. 7 shows the results of the simulation of the relationship between the initial speed and the 90th percentile D₉₀ of the particle size distribution of the phosphor in the phosphor ink for ejection at a stable concentration. The specific gravity p of the phosphor ink was set to 1.5 (g/cm³), the viscosity p of the phosphor ink was set to 10, 15, and 20 (mPa·s), and the diameter L of the nozzle hole 302 was set to 20 (μm).

According to the results of the simulation, in order to eject at a stable concentration the phosphor ink in which the 90th percentile D₉₀ of the particle size distribution of the phosphor is 5 μm or more, the viscosity has to be 10 mPa·s or more.

That is to say, when a phosphor ink containing a phosphor having a median particle diameter of not less than 1.0 μm and the 90th percentile D₉₀ of the particle size distribution of not less than 5 μm is ejected at the initial speed in the range of not less than 4 m/s and not more than 10 m/s using an inkjet device, the viscosity of the phosphor ink has to be not less than 10 mPa·s in order to allow the Stokes number to be 0.1 or less. In this case, the Stokes number is 0.1 or less, and therefore, the concentration of the phosphor particles in the droplet to be ejected can be kept stably. According to this, a PDP can be produced without deteriorating quality of the image of the PDP. Hence, it is preferable that the viscosity of the phosphor ink at 25° C. be not less than 10 mPa·s, since the phosphor ink can be ejected at a stable concentration even though the particle size distribution of the phosphor particles is broad. (Investigation of volume of droplet 303)

The result that the volume of the droplet 303 is preferably 1/100 or less of the internal volume of the discharge cell 11 was found by the following experiments.

The results of the application experiments on the volume of the droplet 303 are shown in Table 3. The experiments were carried out under the 5 conditions in which the ratio of the volume of the droplet 303 relative to the internal volume of the discharge cell 11 was changed from 0.4% to 1.9%. Specifically, the droplet 303 was ejected into the discharge cell 11 using an inkjet device at the volume ratio relative to the internal volume of discharge cell 11 of 0.4%, 0.8%, 1.2%, 1.6%, and 1.9%. In this regard, the nozzle hole 302 was located above the center of the discharge cell 11. Thereafter, an observation was carried out using an optical microscope to confirm whether the droplet 303 was applied in the discharge cell 11 or not, that is to say, whether the droplet 303 was applied outside of the barrier rib 9 or not.

The case where the droplet 303 was applied outside the barrier rib was judged as a failure. The test was carried out 5 times under the each condition. Table 3 shows the number of failures under the each condition. It should be noted that the filling ratio of the phosphor ink was about ⅓ of the internal volume of the discharge cell in the all conditions. In other words, the droplet 303 was ejected several times in one test until the phosphor ink was filled to about ⅓ of the internal volume of the discharge cell. The median particle diameter of the phosphor contained in the phosphor ink used was 3.45 μm. The internal volume of the discharge cell 11 was 1.75×10⁻¹² m³ (length: 250 μm, width: 70 μm, depth: 100 μm).

TABLE 3
Application experiment on volume of droplet

| Ratio of droplet volume relative to | | |
|---|---|---|
| internal volume of discharge cell [%] | Number of test | Number of failure |
| 0.4% | 5 | 0 |
| 0.8% | 5 | 0 |
| 1.2% | 5 | 1 |
| 1.6% | 5 | 2 |
| 1.9% | 5 | 4 |

When the ratio of the volume of the droplet 303 relative to the internal volume of the discharge cell 11 was less than 1%, no failure was observed. Accordingly, in order to maintain high yield, it is preferable that the volume of the droplet 303 of the phosphor ink to be ejected from the inkjet nozzle be less than 1/100 of the internal volume of the discharge cell 11. Particularly, when the phosphor ink containing a phosphor having a median particle diameter of 1.0 μm or more is used, the direction of ejection of droplet 303 ejected from the nozzle hole 302 may not be constant, and therefore, the failure remarkably tends to increase.

It should be noted that the internal volume of the discharge cell 11 means an internal volume of a space in which the four sides of the space are surrounded by the barrier rib 9 and the bottom of the space is formed by the dielectric layer 8.

### Second Embodiment

Next, the second embodiment of the present invention will be described. The second embodiment differs from the first embodiment only in that each phosphor ink is different. Hence, only the phosphor inks will be described.

In the second embodiment, the phosphor ink is free from a binder made of a resin such as ethyl cellulose. In the second embodiment, the each phosphor ink has a good storage property. When a phosphor ink containing a binder made of a resin is stored sitting still, the phosphor particles settle with time, and precipitate on the bottom of a storage vessel of the phosphor ink. When the phosphor ink is left in this state, the phosphor particles may be bound by the resin component. However, the binder made of a resin is not added to the phosphor ink in this embodiment, and therefore, the phosphor particles are not bound even though the phosphor particles settle out during storage. The phosphor that has settled out in the each phosphor ink can be dispersed in the phosphor ink again by vibrating at an ultrasonic frequency and the like. On the other hand, when a phosphor ink contains a binder made of a resin such as ethyl cellulose, application of the phosphor ink to a side of a barrier rib becomes easy. However, when the phosphor ink is free from a binder made of a resin, the zeta potential of the phosphor is minus and the phosphor easily attaches to a barrier rib having a plus potential. Thus, application of the phosphor ink free from a binder made of a resin to a side of a barrier rib is also easy.

Hence, it is also preferable that in the second embodiment, the ink essentially consists of a phosphor, a solvent, and a dispersant.

As an example of the phosphor ink in the embodiment, a phosphor ink was prepared using butyl carbitol acetate and terpineol as a solvent. A phosphor was added at the content of 50 wt %, and a dispersant was added at the content of 0.5 wt % with respect to the weight of the phosphor. A binder made of a resin such as ethyl cellulose was not added. The viscosity of the phosphor ink was measured at 25° C. and found to be 15 mPa·s.

### Other Embodiment

The embodiments of the present invention are described as above. However, the present invention is not limited thereto. Other embodiments of the present invention are described collectively here.

(1) A median particle diameter of a phosphor, a particle size distribution of a phosphor, a kind of a solvent, a kind of additives, a weight ratio of components, and the like in a phosphor ink of the one color may be different from those in a phosphor ink of another color, respectively.
(2) One phosphor material may be used alone for each color, and a mixture of two or more kinds of phosphor materials may be used.

### [Application of PDP]

Next, a PDP device, which is an application of the PDP to be obtained by the production method of the present invention, will be described.

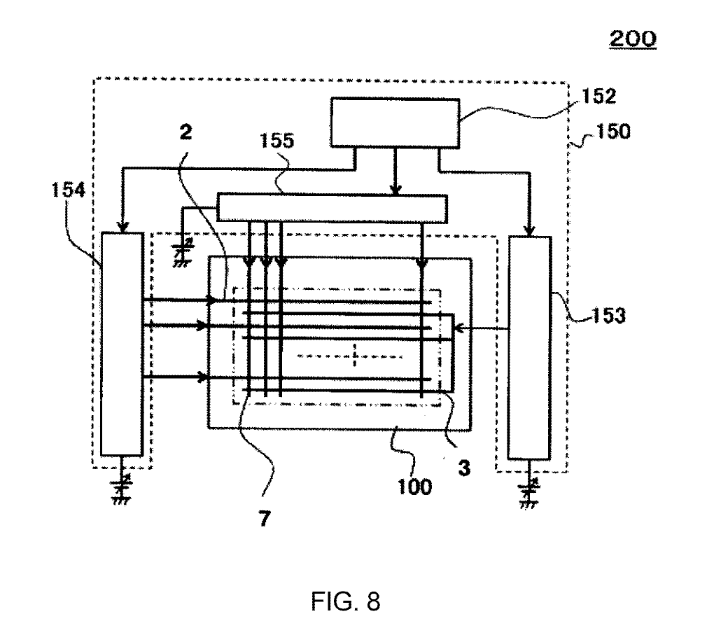

FIG. 8 is a schematic view of a structure of a PDP device 200 using the PDP 100. The PDP device is constructed by connecting the PDP 100 to a drive device 150. A display driver circuit 153, a display scan driver circuit 154, and an address driver circuit 155 are connected to the PDP 100. A controller 152 controls a voltage to be applied to these. An address discharge is generated by applying a predetermined voltage to a scan electrode 2 and a data electrode 7 in a discharge cell to be illuminated. The controller 152 controls this voltage to be applied. Thereafter, a pulse voltage is applied to between a sustain electrode 3 and the scan electrode 2 to generate a sustained discharge. Due to this sustained discharge, an ultraviolet ray is generated in the discharge cell in which the address discharge has been generated. A phosphor layer is excited by this ultraviolet ray and then emits light, so that the discharge cell is illuminated. A combination of lighting cells and non-lighting cells of respective colors displays an image.

### Feature of Embodiment

Features of the above embodiments will be listed below. It should be noted that the present invention is not limited to the below features.

[C1] A method for producing a plasma display panel includes a step of providing a back substrate with a barrier rib to form a plurality of recesses separated each other by the barrier rib, and a step of applying a phosphor ink to the recesses using an inkjet device,

wherein the phosphor ink contains a phosphor having a median particle diameter of not less than 1.0 μm, and a solvent, and

an initial speed of the phosphor ink ejected from a nozzle hole of the inkjet device is not less than 4 m/s and not more than 10 m/s.

According to the method, an ink containing phosphor particles having a median particle diameter of not less than 1.0 μm can be ejected stably using an inkjet device.

[C2] In the method for producing a plasma display panel according to C1, it is preferable that the diameter of the nozzle hole of the inkjet device be not more than 30 μm.

In this case, the initial speed of the phosphor ink (e.g., droplet 303) ejected from the nozzle hole can be adjusted easily to not less than 4 m/s and not more than 10 m/s.

[C3] In the method for producing a plasma display panel according to C1, it is preferable that the content of the phosphor in the phosphor ink be not less than 30 wt % and not more than 70 wt %.

In this case, a plasma display panel can be produced efficiently using an inkjet device.

[C4] In the method for producing a plasma display panel according to C1, it is preferable that the specific gravity of the phosphor ink be not less than 1.1 g/cm³.

In this case, the thickness of the phosphor ink that can be applied in one scan is large, and therefore, it is possible to apply the phosphor ink to have a predetermined thickness in, for example, one scan. It should be noted that a scan means a step including ejecting one or more of droplets of a phosphor ink from a nozzle hole and subsequently drying the phosphor ink.

[C5] In the method for producing a plasma display panel according to C1, it is preferable that the viscosity of the phosphor ink at 25° C. be not less than 10 mPa·s and not more than 50 mPa·s.

In this case, the phosphor particles are prevented from precipitating and agglomerating in the inkjet device, and ejection of the ink from a nozzle hole of an inkjet head is performed easily.

[C6] In the method for producing a plasma display panel according to C1, it is preferable that the volume of the phosphor ink ejected in one ejection from the nozzle hole of the inkjet device be less than 1/100 of the internal volume of the recess.

In this case, the phosphor ink can be applied using a inkjet device with high yield.

[C7] In the method for producing a plasma display panel according to C1, it is preferable that the phosphor ink be filled to 30% or more of the internal volume of the recess.

In this case, a phosphor layer having a sufficient thickness with little degradation of luminance can be formed.

[C8] In one preferred embodiment of the method for producing a plasma display panel according to C1, the phosphor ink is free from a binder made of a resin.

According to this embodiment, even though the phosphor particles settle out during storage of the phosphor ink, the phosphor particles are not bound. Therefore, the storage of the phosphor ink is easy, and the phosphor ink can be used easily for the application after the storage.

The invention may be embodied in other forms without departing from the spirit or essential characteristics thereof. The embodiments disclosed in this specification are to be considered in all respects as illustrative and not limiting. The scope of the invention is indicated by the appended claims rather than by the foregoing description, and all changes which come within the meaning and range of equivalency of the claims are intended to be embraced therein.

### INDUSTRIAL APPLICABILITY

As described above, the present invention is useful for achieving easily a high definition PDP.

What is claimed is:

1. A method for producing a plasma display panel, comprising
a step of providing a back substrate with a barrier rib to form a plurality of recesses separated each other by the barrier rib, and
a step of applying a phosphor ink to the recesses using an inkjet device,
wherein the phosphor ink contains a phosphor having a median particle diameter of not less than 1.0 μm, and a solvent, and
an initial speed of the phosphor ink ejected from a nozzle hole of the inkjet device is not less than 4 m/s and not more than 10 m/s.

2. The method for producing a plasma display panel according to claim 1, wherein the diameter of the nozzle hole of the inkjet device is not more than 30 μm.

3. The method for producing a plasma display panel according to claim 1, wherein the content of the phosphor in the phosphor ink is not less than 30 wt % and not more than 70 wt %.

4. The method for producing a plasma display panel according to claim 1, wherein the specific gravity of the phosphor ink is not less than 1.1 g/cm³.

5. The method for producing a plasma display panel according to claim 1, wherein the viscosity of the phosphor ink at 25° C. is not less than 10 mPa·s and not more than 50 mPa·s.

6. The method for producing a plasma display panel according to claim 1, wherein the volume of the phosphor ink ejected in one ejection from the nozzle hole of the inkjet device is less than 1/100 of the internal volume of the recess.

7. The method for producing a plasma display panel according to claim 1, wherein the phosphor ink is filled to 30% or more of the internal volume of the recess.

8. The method for producing a plasma display panel according to claim 1, wherein the phosphor ink is free from a binder made of a resin.
